(19) United States
(12) Patent Application Publication
(10) Pub. No.: US 2013/0097927 A1
(43) Pub. Date: Apr. 25, 2013

(54) REINFORCED SLOPE PLANTING STRUCTURE

(71) Applicant: Yushun Chang, Guang Dong (CN)

(72) Inventor: Yushun Chang, Guang Dong (CN)

(21) Appl. No.: 13/716,999

(22) Filed: Dec. 17, 2012

Related U.S. Application Data
(63) Continuation-in-part of application No. 12/518,104, filed on Jun. 6, 2009, now abandoned.

(30) Foreign Application Priority Data
Aug. 14, 2007 (CN) CN 200720055485.X

(51) Int. Cl. A01G 7/00

(52) U.S. Cl. CPC A01G 7/00
USPC 47/1.1 T; 47/66.7

(57) ABSTRACT

A method for slope planting, including the steps of: forming at least one hole in a slope; piercing, by at least one fastener, through a vegetation bag that is ventilative and pervious to water and into the hole in the slope, to fasten the vegetation bag; applying cement or adhesive to the vegetation bag and/or the slope to form a reinforcing layer for combining the vegetation bag with the slope; and filling the vegetation bag with stuffing. The present invention further discloses a slope planting structure as constructed by the method, and a reinforced slope planting structure.

### RELATED APPLICATIONS

This application is a continuation-in-part of U.S. application Ser. No. 12/518,104 filed Jun. 6, 2009, which is a 371 of PCT/CN07/03357 filed Nov. 28, 2007 which claims the benefit of CN 200720055485.X filed Aug. 14, 2007. The entire teachings of the above-referenced applications are incorporated herein by reference.

### FIELD OF THE INVENTION

The present invention relates to technologies for slope planting, and more particularly to a reinforced slope planting structure that can enhance the stability of slopes for planting with various inclinations, especially steep inclinations. The application also relates to a method for slope planting, which is applicable to slopes with various inclinations, especially steep inclinations.

### BACKGROUND OF THE INVENTION

A conventional slope structure is composed of cement, stone, steel bar, sand, and earth. The concrete structure is not environmental and beautiful, and is easy to be damaged by thermal expansion and contraction under the irradiation of sunlight. Besides, the conventional slope structure causes destruction to ecology.

Green environmental engineering is advocated constantly, which becomes an international responsibility gradually. The aforesaid concrete slope usually uses nets to spray nutritional soil and sod for green planting. After a period of time, the nutritional soil will not be fertile because of weathering or be washed away by rain to lose green planting effect and bare a bleak slope.

Accordingly, the inventor of the present invention has devoted himself based on his many years of practical experiences to the development of green construction design and filed several patent applications during the years of 2005 to 2006, referring to Chinese Patent Nos, ZL 200520103935.9, ZL200520145284X, ZL200620001854.2. However, in the process of construction, the applicant found out the steadiness of the entire slope is not firm and perfect. Accordingly, it is necessary to improve the slope planting structure.

In the prior art, vegetation bags are filled with stuffing and than subsequently placed and fastened on the planting slope. However, for the purpose of planting a slope with a steep inclination of e.g. 80 degrees or above, or 90 degrees or above, especially a rock slope which is typically steep, it is very difficult to place and fasten the vegetation bags on the planting slope due to the large heavy of the vegetation bags and the stuffing therein.

Particularly, when adhesive is applied to the vegetation bag and/or the slope to fasten the bag on the slope, especially a steep slope, the vegetation bag usually cannot be fastened on the slope due to its gravity before the adhesive is solidified. Because the adhesive take some time to solidify, the vegetation bag would fall before the solidification, and thus fasteners use for piercing through the bag and into the slope are required for the fastening of the vegetation bag on the slope. However, the fasteners piercing through the bag and into the slope might be loosened with time and cannot withstand the weight of the vegetation bags with stuffing for a long time, especially in the case of a steep slope, and the fastener may be even more loosened if plants are grown on the vegetation bags, and might be released from the slope eventually, and hence the vegetation bags would fall down from the slope.

### SUMMARY OF THE INVENTION

The present invention is to overcome the shortcomings of the prior art. The primary objective of the present invention is to provide a reinforced slope planting structure for plant growing so as to achieve environmental protection and beauty effects and to firm and protect the slope. The present invention also proposes a method for slope planting. With the solutions of the invention, both fasteners and reinforcing layers are employed, and advantages of easy construction of the reinforced slope planting structure and of improved durability of the reinforced slope planting structure are achieved.

According to a first aspect of the present invention, there is provided a method for slope planting, including the steps of: forming at least one hole in a slope; piercing, by at least one fastener, through a vegetation bag that is ventilative and pervious to water and into the hole in the slope, to fasten the vegetation bag; applying cement or adhesive to the vegetation bag and/or the slope to form a reinforcing layer for combining the vegetation bag with the slope, and filling the vegetation bag with stuffing.

Preferably, the step of piercing, through a vegetation bag and into the slope by at least one fastener further includes: passing the fastener through an interlocking member, which is placed at the side of the vegetation bag that is opposite to or facing the slope, and is adapted to interlock adjacent vegetation bags.

Preferably, the interlocking member may include a base and protrusions on a surface of the base for piercing into the vegetation bag, and the base is formed with at least one aperture for insertion by the fastener.

Preferably, the stuffing is plant growing material, and more preferably, the stuffing further contains plant seeds.

Preferably, the method further includes: spraying plant seeds on a surface of the vegetation bag or between multiple layers of fabric forming a body of the vegetation bag; or paving an exposed surface of the vegetation bag with sod; or planting young plants on an exposed surface of the vegetation bag,

Preferably, the vegetation bag is made in the form of a block or an elongated rod.

According to a second aspect of the present invention, the present invention further discloses a slope planting structure as constructed by the method above.

According to a third aspect of the present invention, there is provided a reinforced slope planting structure, comprising a plurality of vegetation bags filled with stuffing and a plurality of fasteners, the vegetation bags being ventilative and pervious to water and being laid on a slope, the fasteners penetrating through the vegetation bags and into the slope for securing the vegetation bags to the slope integrally, and a reinforcing layer is provided between the vegetation bags and the slope.

Preferably, the reinforcing layer is either cement or adhesive.

Preferably, an interlocking member is provided between adjacent vegetation bags and disposed on upper surfaces of the adjacent vegetation bags, the interlocking member comprising a base and protrusions on a surface of the base or interlocking the adjacent vegetation bags. Preferably, the base is formed with at least one aperture for insertion by the fasteners.

Preferably, the plant seeds are sprayed on a surface of the vegetation bag, mixed with the stuffing, or laid between multiple layers of fabric forming a body of the vegetation bag; or an exposed surface of the vegetation bag is paved with sod, or planted with young plants.

Preferably, the vegetation bags are made in the form of a block or an elongated rod.

According to a fourth aspect of the present invention, there is provided a reinforced slope planting structure, comprising a plurality of vegetation bags filled with stuffing and a plurality of fasteners, the vegetation bags being ventilative and pervious to water, an upper surface of the vegetation bags being paved with sod or planted with young plants, a lower surface of the vegetation bags being attached to a slope, the fasteners penetrating into the vegetation bags for securing the vegetation bags to the slope so as become an integral whole, and characterized in that: a reinforcing layer is provided between the vegetation bags and the slope.

Preferably, the reinforcing layer is either of cement and adhesive.

Preferably, an interlocking member is provided between adjacent vegetation bags and disposed on upper surfaces of the two adjacent vegetation bags, the interlocking member comprising a base and protrusions on a surface of the base for interlocking the adjacent vegetation bags, the base being formed with at least one aperture for insertion of the fasteners.

Preferably, the vegetation bags are made in the form of a block or an elongated rod.

Comparing to the prior art, the advantage of the present invention is that between the vegetation bags which are filled with the stuffing and preferably the plant seeds or paved with the sod and the slope is the reinforcing layer. The present invention provides a green layer for plant growing, firming and protecting the slope as well as greening and beautifying the slope. The present invention also provides a green ecology to improve the air and to absorb heat and noise. The invention adapts both the fasteners and the reinforcing layers, to facilitate the construction of the slope planting structure, especially in the case of a steep slope, and fix the vegetation bags on the slope integrally for a long term without separation of the bags from the slope.

### BRIEF DESCRIPTION OF THE DRAWINGS

FIG. 1 is a schematic view of a first preferred embodiment of the present invention;

FIG. 2 is a schematic view of a second preferred embodiment of the present invention;

FIG. 3 is a schematic view of a third preferred embodiment of the present invention;

FIG. 4 is a schematic view of a fourth preferred embodiment of the present invention; and

FIG. 5 is a schematic view of a fifth preferred embodiment of the present invention.

### DETAILED DESCRIPTION OF THE INVENTION

Embodiments of the present invention will now be described, by way of example only, with reference to the accompanying drawings.

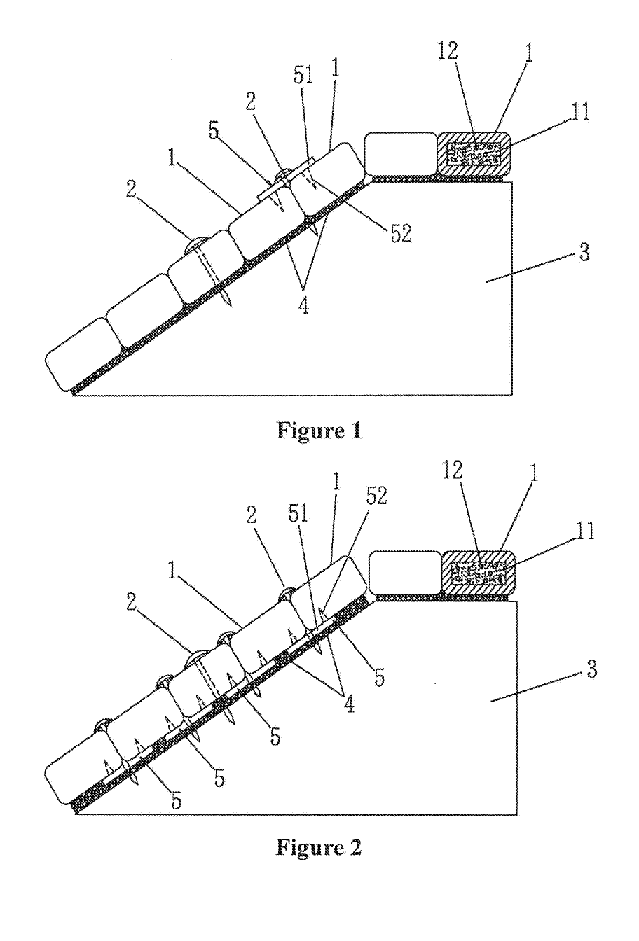

As shown in FIG. 1, a reinforced slope planting structure according to a first preferred embodiment of the present invention comprises a plurality of vegetation bags 1 filled with stuffing 11 and a plurality of fasteners 2. In this embodiment, the vegetation bags 1 are made in the form of a block, which are ventilative and pervious to water. The stuffing 11 of the vegetation bags 1 is mixed with plant seeds 12. The plant seeds 12 may be sprayed on the surface of the vegetation bags or laid between multiple layers in the vegetation bags. The vegetation bags 1 are laid on the surface of a slope 3. The fasteners 2 correspond in position to the vegetation bags 1 and penetrate into the vegetation bags 1 for securing the vegetation bags 1 to the slope 3. A reinforcing layer 4 is provided between the vegetation bags 1 and the slope 3 so that the vegetation bags and the slope become an integral whole. The reinforcing layer 4 is selected from cement or adhesive (such as glue). The reinforcing layer 4 is preset on the slope 3, and the vegetation bags 1 are laid on the reinforcing layer 4. The fasteners 2 penetrate through the vegetation bags 1 to secure the vegetation bags 1 on the slope 3. Thus, the reinforced slope planting structure of the present invention is achieved.

In the aforesaid embodiment, in order to firm the reinforced slope planting structure securely, an interlocking member 5 is provided between two adjacent vegetation bags 1 and disposed on upper surfaces of the two adjacent vegetation bags. The interlocking member 5 comprises a base 51 and protrusions 52 on a surface of the base 51 for interlocking the vegetation bags. The base 51 may be formed with an aperture at a central portion thereof (not shown in the drawings) for insertion of the fastener 2.

FIG. 2 is a second preferred embodiment of the present invention, which is substantially similar to the first preferred embodiment with the exceptions described hereinafter. The interlocking member 5 is disposed between lower surfaces of two adjacent vegetation bags 1 and the reinforcing layer 4. The protrusions 52 provided on an upper surface of the base 51 of the interlocking member 5 is adapted to interlock the bottoms of the two adjacent vegetation bags 1. A lower surface of the base 52 is attached to the reinforcing layer 4 firmly. The base may be formed with an aperture at a central portion thereof (not shown in the drawings) for a different configuration of the slope. The fastener 2 is inserted through the aperture of the base and into the reinforcing layer 4 and secured to the slope 3. Accordingly, the vegetation bag I is secured to the slope 3 firmly through the interlocking member 5.

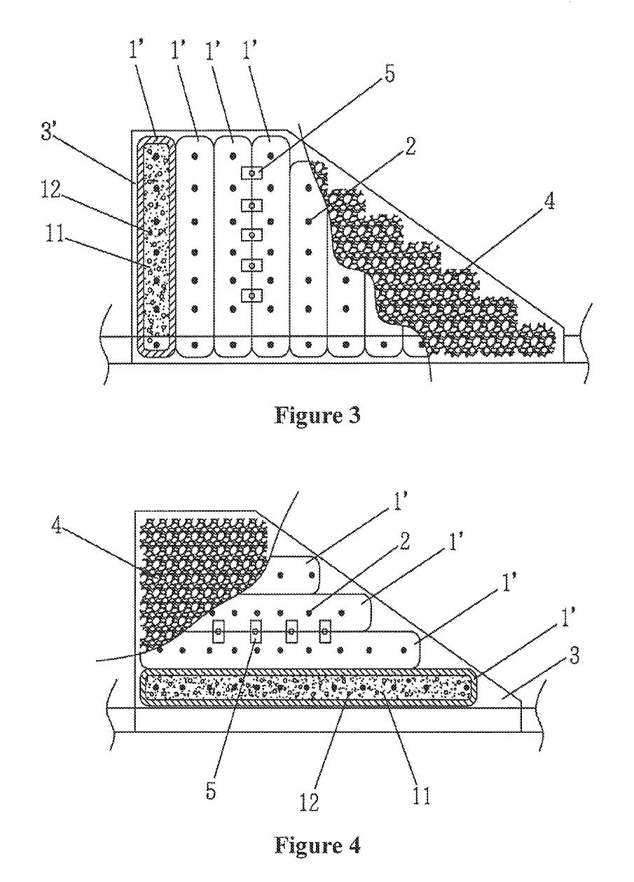

FIG. 3 is a third preferred embodiment of the present invention, which is substantially similar to the first preferred embodiment with the exceptions described hereinafter. The vegetation bag 1′ is made in the form of an elongated rod instead of the block, which is applied to a side surface of the slope. The slope 3 is provided with the reinforcing layer (cement or adhesive), and then the elongated vegetation bags 1 are arranged longitudinally from the top to the bottom of the slope 3. The bottom of the vegetation bag 1′ may be covered with earth (or not be covered with earth). The number of the fasteners 2 depends on the gradient of the slope 3 for securing the elongated vegetation bags 1 and the reinforcing layer to the slope 3. In this embodiment, the interlocking member 5 is the same as the aforesaid first preferred embodiment, and doesn't be described hereinafter.

FIG. 4 is a fourth preferred embodiment of the present invention, which is substantially similar to the third preferred embodiment with the exceptions described hereinafter. The elongated vegetation bags 1′ are laid transversely from the inclination to the side of the slope 3. The fastener 2, the reinforcing layer 4, and the interlocking member 5 are the same as the aforesaid embodiments, and don't be described hereinafter.

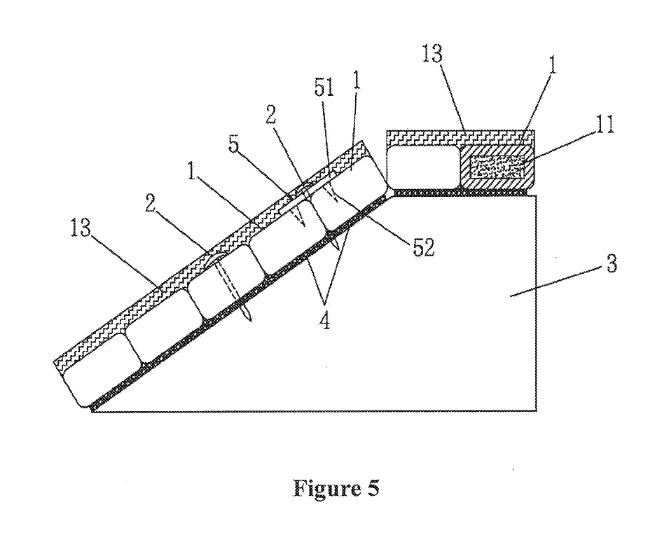

FIG. 5 is a fifth preferred embodiment of the present invention, which is substantially similar to the first preferred embodiment with the exceptions described hereinafter. The vegetation bag 1 is covered with sod 13 instead of the plant seeds 12 in the vegetation bag 1 for providing a green effect quickly and directly. The slope 3 is provided with the reinforcing layer (cement or adhesive), and then the vegetation bags 1 are laid on the reinforcing layer 4. The fasteners 2 penetrate through the vegetation bags 1 to secure the vegetation bags 1 on the slope 3. Finally, the sod 13 is laid on the vegetation bags 1. The other parts, such as the interlocking member 5, are the same, and don't be described hereinafter. In this embodiment, except the sod, the vegetation bags may be planted with saplings, flowers, plants and the like. This way of paving with sod and planting with young plants is also applied to the aforesaid first, second, third, and fourth embodiments. The arrangement of the interlocking member 5 in the second embodiment is also applied to the third, fourth, and fifth embodiments.

According to the aforesaid embodiments, the feature of the present invention is that between the vegetation bags which are filled with the stuffing and the plant seeds or paved with the sod and the slope is the reinforcing layer. The present invention provides a green layer for plant growing, firming and protecting the slope as well as greening and beautifying the slope. The present invention also provides a green ecology to improve the air and to absorb heat and noise.

According to an embodiment of the invention, there is provided a method for slope planting, including steps of: forming at least one hole in a slope 3 and 3′; piercing, by at least one fastener 2, through a vegetation bag 1 and 1′ that is ventilative and pervious to water and into the hole in the slope 3 and 3′, to fasten the vegetation bag 1 and 1′; applying cement or adhesive to the vegetation bag 1 and 1′ and/or the slope 3 and 3′ to form a reinforcing layer 4 for combining the vegetation bag 1 and 1′ with the slope 3 and 3′; and filling the vegetation bag 3 and 3′ with stuffing.

In contrary to the prior art, in the method above, an empty vegetation bag is fastened and then filled with stuffing, so that the method is applicable to slopes with various inclinations, especially a steep slope with an inclination of, e.g. 80 degrees or above, or 90 degrees or above. The slope may be a hard slope, such as a rock slope and a concrete slope. In the method, the step of filling the vegetation bag with stuffing may be performed before the cement or adhesive is solidified or in the process of the solidification of the cement or adhesive, at this time, the vegetation bag is mainly fastened by the fastener, and then by both the fastener and the solidified cement or adhesive eventually, this solution is more suitable for a gentle slope. Alternatively, the step of filling the vegetation bag with stuffing may be performed after the cement or adhesive is solidified, at this time, the vegetation bag is fastened by both the fastener and the solidified cement or adhesive, and this solution is more suitable for a steep slope.

That is, both the reinforcing layer (formed by the cement or adhesive) and the fastener are used for fastening. In use, the fastener is firstly fixed in the slope to support and prevent the vegetation bag from falling down from the slope, meanwhile the applied cement or adhesive may solidifies. After the solidification of the cement or adhesive, the vegetation bag may be stuck to the slope integrally. The slope planting structure thus obtained is more stable and durable, and more suitable for steep slopes.

The method and the reinforced slope planting structure of the invention are advantageous in that: (1) the cement or adhesive may penetrate into the slope, to enhance the stiffness of the slope; (2) the cement or adhesive may penetrate into the vegetation bag, so that the partial stuffing inside the bag may be combined firmly; (3) the combined stuffing and the enhanced slope are formed into a single piece through the reinforcing layer from by the cement or adhesive; and (4) the fastener pierces through the vegetation bag including the combined stuffing and the enhanced slope, to further combine the bag and the slope. Further, the fastener may be more firmed fixed in the slope due to the enhancement of the slope.

With the combination of the fastener and the reinforcing layer, the construction of the slope planting structure is facilitated, and the structure would not be broken even if the fastener is eroded because the bag and the slope is formed as a single piece due to the reinforcing layer.

Preferably, the step of piercing, through a vegetation bag and into the slope by at least one fastener may further include: passing the fastener through an interlocking member, which is placed at the side of the vegetation bag that is opposite to or facing the slope, and is adapted to interlock adjacent vegetation bags.

Preferably, the interlocking member may include a base and protrusions on a surface of the base for piercing into the vegetation bag, and the base is formed with at least one aperture for insertion by the fastener.

Preferably, the stuffing is plant growing material, and more preferably, the stuffing further contains plant seeds.

Preferably, the method further includes: spraying plant seeds on a surface of the vegetation bag or between multiple layers of fabric forming a body of the vegetation bag; or paving an exposed surface of the vegetation bag with sod; or planting young plants on an exposed surface of the vegetation bag.

Preferably, the vegetation bag is made in the form of a block or an elongated rod.

According to a second aspect of the present invention, the present invention further discloses a slope planting structure as constructed by the method above.

Although particular embodiments of the present invention have been described in detail for purposes of illustration, various modifications and enhancements may be made without departing from the spirit and scope of the present invention. Accordingly, the present invention is not to be limited except as by the appended claims.

1. A method for slope planting, comprising the steps of:
forming at least one hole in a slope;
piercing, by at least one fastener, through a vegetation bag that is ventilative and pervious to water and into the hole in the slope, to fasten the vegetation bag;
applying cement or adhesive to the vegetation bag and/or the slope to form a reinforcing layer for combining the vegetation bag with the slope; and
filling the vegetation bag with stuffing.

2. The method of claim 1, wherein the step of piercing, through a vegetation bag and into the slope by at least one fastener further comprises:
passing the fastener through an interlocking member, which is placed at the side of the vegetation bag that is opposite to or facing the slope, and is adapted to interlock adjacent vegetation bags.

3. The method of claim 2, wherein the interlocking member comprises a base and protrusions on a surface of the base for piercing into the vegetation bag, and the base is formed with at least one aperture for insertion by the fastener.

4. The method of claim 1, wherein the stuffing is plant growing material.

5. The method of claim 4, wherein the stuffing further contains plant seeds.

6. The method of claim 1, further comprising:
spraying plant seeds on a surface of the vegetation bag or between multiple layers of fabric forming a body of the vegetation bag; or
paving an exposed surface of the vegetation bag with sod; or
planting young plants on an exposed surface of the vegetation bag.

7. The method of claim 1, wherein the vegetation bag is made in the form of a block or an elongated rod.

8. A slope planting structure as constructed by the method of claim 1.

9. A reinforced slope planting structure, comprising a plurality of vegetation bags filled with stuffing and a plurality of fasteners, the vegetation bags being ventilative and pervious to water and laid on a slope, the fasteners penetrating through the vegetation bags and into the slope for securing the vegetation bags to the slope integrally, and a reinforcing layer is provided between the vegetation bags and the slope.

10. The reinforced slope planting structure of claim 9, wherein the reinforcing layer is either of cement and adhesive.

11. The reinforced slope planting structure of claim 9, wherein, plant seeds are sprayed on a surface of the vegetation bag, mixed with the stuffing, or laid between multiple layers of fabric forming a body of the vegetation bag; or an exposed surface of the vegetation bag is paved with sod, or planted with young plants.

12. The reinforced slope planting structure of claim 9, wherein the vegetation bag is made in the form of a block or an elongated rod.
